(19) United States
(12) Patent Application Publication
(10) Pub. No.: US 2021/0403333 A1
(43) Pub. Date: Dec. 30, 2021

(54) METHOD FOR PREPARING HIERARCHICAL POROUS TITANOSILICATE TS-1 MOLECULAR SIEVE

(71) Applicant: DALIAN INSTITUTE OF CHEMICAL PHYSICS, CHINESE ACADEMY OF SCIENCES, Dalian City, Liaoning Province (CN)

(72) Inventors: Danhua YUAN, Dalian City, Liaoning (CN); Jiacheng XING, Dalian City, Liaoning (CN); Yunpeng XU, Dalian City, Liaoning (CN); Zhongmin LIU, Dalian City, Liaoning (CN)

(73) Assignee: DALIAN INSTITUTE OF CHEMICAL PHYSICS, CHINESE ACADEMY OF SCIENCES, Dalian City, Liaoning Province (CN)

(21) Appl. No.: 17/294,356

(22) PCT Filed: Nov. 15, 2018
(86) PCT No.: PCT/CN2018/115720

§ 371 Date: May 14, 2021

(51) Int. Cl. C01B 37/00; B01J 29/89

(52) U.S. Cl. CPC C01B 37/005; C01P 2002/74; C01P 2006/16; B01J 29/89

(57) ABSTRACT

The present application discloses a method for preparing hierarchical porous titanium-silicon TS-1 molecular sieve, wherein a titanate polyester polyol is used as titanium source. In the method, titanium is connected to a polymer, which makes titanium more difficult to hydrolyze, prevent the TiO₂ precipitation and reduce the formation of non-framework titanium. In addition that such new type of the titanate polyester polyol acts as the titanium source during the synthesis process, the titanate polyester polyol can also be used as mesoporous template. Therefore, the TS-1 molecular sieve obtained by this method has mesoporous structure, which plays an important role in promoting the application of TS-1 molecular sieve in the field of catalysis.

### FIELD

The present application relates to a method for preparing hierarchical porous titanium-silicon TS-1 molecular sieve, which belongs to the field of preparation of molecular sieve.

### BACKGROUND

TS-1 molecular sieve is a kind of microporous molecular sieve with MFI topological structure. Due to the presence of tetrahedral Ti⁴⁺ sites in its framework structure, it has a good catalytic effect on the selective oxidation of organics in the presence of H₂O₂, such as the epoxidation of olefins, the hydroxylation of phenol, the ammoximation of ketones, the oxidation of alkanes and other selective oxidation reactions. The catalytic oxidation process with TS-1 molecular sieve is pollution-free and the reaction conditions are mild, which overcomes the disadvantages of serious pollution and lengthy reaction process in the traditional process.

There are two main factors affecting the activity and stability of TS-1 molecular sieve: one is the content of framework titanium and non-framework titanium in the molecular sieve, and the other is the diffusion performance of the molecular sieve. For the former factor, due to the large radius of titanium atom, it is difficult to enter the MFI framework, and further the titanium source is easily hydrolyzed and polymerized to form titanium dioxide precipitate. Thus, it is difficult to avoid the formation of six-coordinated non-framework titanium in the synthesis of TS-1 molecular sieve. However, the existence of the non-framework titanium can promote the ineffective decomposition of H₂O₂ and is not conducive to the oxidation reaction catalyzed by TS-1 molecular sieve. For the latter factor, the pore size of TS-1 molecular sieve is too small which refers to only 0.55 nm, which greatly limits the transmission and diffusion of the organic macromolecules in the catalyst and thus inhibits the reaction activity and service life of the catalyst.

The synthesis of TS-1 was originally reported by Taramasso et al. (U.S. Pat. No. 4,410,501). The synthesis of TS-1 used tetraethyl orthosilicate (TEOS) as silicon source, tetraethyl titanate (TEOT) as titanium source, and tetrapropylammonium hydroxide (TPAOH) as template which were subject to hydrothermal crystallization at a temperature ranging from 130 to 200° C. in a reactor for a time ranging from 6 to 30 days. However, this method is cumbersome to operate, difficult to control conditions, and has poor experimental repeatability. In addition, due to the difference in the hydrolysis rates of the titanium source, a large amount of non-framework titanium is formed, which affects the catalytic performance of TS-1 molecular sieve. Subsequently, Thangaraj et al. (zeolite, 12(1992), 943) pre-hydrolyzed tetraethyl orthosilicate in TPAOH aqueous solution, and then slowly added therein isopropanol solution of tetrabutyl titanate with a slower hydrolysis rate under vigorous stirring conditions. And, TS-1 molecular sieve with less non-framework titanium was obtained. These improvements are mainly to control the hydrolysis process of the titanium source, so that the hydrolysis rates of the titanium source are more matched to inhibit the formation of non-framework titanium, thereby increasing the framework titanium content in the TS-1 molecular sieve.

For the diffusion problem of TS-1 molecular sieve, it is a common solution to introduce mesopores into the zeolite molecular sieve system to prepare the hierarchical porous molecular sieves. Due to the existence of hierarchical pores, the communication and diffusion performances of the catalyst material are greatly improved, thereby effectively enhancing the interaction between the guest molecules and the active sites. It is currently the most effective way to prepare hierarchical porous molecular sieves by using template agents to construct mesoporous or macroporous structures in molecular sieve materials, including soft template method and hard template method. The soft template method is exemplified by Zhou Xinggui et al. (CN103357432A) and Zhang Shufen (CN102910643A), wherein Zhou Xinggui et al. (CN103357432A) uses polyether Pluronic F127 as the mesoporous template to synthesize mesoporous nano-TS-1 molecular sieve by dry gel method; and Zhang Shufen (CN102910643A) uses cetyltrimethylammonium bromide as mesoporous template to introduce mesoporous channels into the titanium silicate molecular sieve. The hard template method is exemplified by Chen Lihua et al. (CN104058423A) and Li Gang et al. (CN101962195A), wherein Chen Lihua et al. (CN104058423A) uses three-dimensional ordered macroporous-mesoporous hierarchical porous carbon material as the hard template to limit the growth of TS-1 nanocrystals in the three-dimensional ordered channels, and then removes the hard template to obtain hierarchical porous titanium-silicon TS-1 molecular sieve; and Li Gang et al. (CN101962195A) uses cheap sugar instead of porous carbon materials as macroporous-mesoporous template agent, which is heated, carbonized and dehydrated to directly form hard template in the process of heat treatment of the TS-1 molecular sieve synthetic gel containing sugar to prepare dry gel, to obtain hierarchical porous TS-1 molecular sieve.

### SUMMARY

According to one aspect of the present application, a method for preparing a TS-1 molecular sieve is provided. In the method, titanate polyester polyol is formed by connecting titanium source to a polymer, which makes titanium more difficult to hydrolyze, prevent the TiO₂ precipitation and reduce the formation of non-framework titanium. In addition that such new type of titanate polyester polyol acts as the titanium source during the synthesis process, the titanate polyester polyol can also be used as mesoporous template. Therefore, the TS-1 molecular sieve obtained by this method has a mesoporous structure, which plays an important role in promoting the application of TS-1 molecular sieve in the field of catalysis.

The method for preparing the hierarchical porous TS-1 molecular sieve is characterized in that the titanate polyester polyol is used as titanium source.

Optionally, the method comprises crystallizing a mixture containing the titanate polyester polyol, silicon source, template and water to obtain the hierarchical porous TS-1 molecular sieve.

Optionally, the crystallization is hydrothermal crystallization.

Optionally, the titanate polyester polyol is at least one of compounds having a chemical formula shown in Formula I:

[Ti(ROₓ)_{4/x}]ₙ Formula I

wherein, ROₓ is a group formed by losing H on OH of the organic polyhydric alcohol R(OH)ₓ, and R is a group formed by losing x hydrogen atoms on a hydrocarbon compound, x≥2; n=2˜30.

Optionally, x=2, 3 or 4 in Formula I.

Optionally, the titanate polyester polyol has the following molecular formula: [Ti(ROₓ)_{4/x}]ₙ; wherein ROₓ is a group formed by losing H on OH of the organic polyhydric alcohol R(OH)ₓ, preferably x=2, 3 or 4.

Optionally, R in Formula I is a group formed by losing x hydrogen atoms on a hydrocarbon compound.

Optionally, R in Formula I is a group formed by losing x hydrogen atoms of C₁˜C₈ hydrocarbon compound.

Optionally, the titanate polyester polyol is at least one of titanate ethylene glycol polyester, titanate butylene glycol polyester, titanate polyethylene glycol polyester, titanate glycerol polyester and titanate terephthalyl alcohol polyester.

Optionally, the titanate polyethylene glycol polyester is at least one of titanate polyethylene glycol 200 polyester, titanate polyethylene glycol 400 polyester, titanate polyethylene glycol 600 polyester, and titanate polyethylene glycol 800 polyester.

Optionally, the method for preparing the titanate polyester polyol comprises performing transesterification of raw materials containing titanate and polyhydric alcohol to obtain the titanate polyester polyol.

Optionally, the titanate comprises at least one of tetraethyl titanate, tetraisopropyl titanate, tetrabutyl titanate, tetrahexyl titanate and tetraisooctyl titanate.

Optionally, a molar ratio of the titanate to the polyhydric alcohol satisfies:
titanate:polyhydric alcohol=(0.8˜1.2)n³/x,
wherein x is the number of moles of alkoxyl groups contained in each mole of titanate, and
n³ is the number of moles of hydroxyl groups contained in each mole of polyhydric alcohol.

Optionally, the upper limit of the molar ratio of the titanate to the polyhydric alcohol is 0.85 n³/x, 0.9 n³/x, 0.95 n³/x, 1 n³/x, 1.05 n³/x, 1.1 n³/x, 1.15 n³/x or 1.2 n³/x, and the lower limit thereof is 0.8 n³/x, 0.85 n³/x, 0.9 n³/x, 0.95 n³/x, 1 n³/x, 1.05 n³/x, 1.1 n³/x or 1.15 n³/x; wherein, x is the number of moles of alkoxy groups contained in each mole of the titanate, and n³ is the number of moles of hydroxyl groups contained in each mole of the polyhydric alcohol.

Optionally, the number of hydroxyl groups in the polyhydric alcohol is not less than two.

Optionally, the polyhydric alcohol comprises at least one of ethylene glycol, diethylene glycol, triethylene glycol, tetraethylene glycol, 1,2-propanediol, 1,3-propanediol, 1,4-butylene glycol, 1,6-hexanediol, polyethylene glycol 200, polyethylene glycol 400, polyethylene glycol 600, polyethylene glycol 800, 1, 4-cyclohexanediol, 1,4-cyclohexane dimethanol, terephthalyl alcohol, glycerin, trimethylolpropane, pentaerythritol, xylitol and sorbitol.

Optionally, the formula of the polyhydric alcohol is R²—(OH)ₓ, wherein x≥2.

Optionally, the molar ratio of the titanate to the polyhydric alcohol satisfies: (0.8˜1.2) n/x; wherein, x is the number of moles of alkoxy groups contained in each mole of the titanate, and n is the number of moles of hydroxyl groups contained in each mole of the polyhydric alcohol.

Optionally, the transesterification is carried out in the presence of a transesterification catalyst.

Optionally, the amount of the transesterification catalyst is in a range from 0.1 wt % to 5 wt % of the titanate.

Optionally, the upper limit of amount of the transesterification catalyst is 0.2 wt %, 0.5 wt %, 0.8 wt %, 1.0 wt %, 1.5 wt %, 2.0 wt %, 2.5 wt %, 3.0 wt %, 3.5 wt %, 4.0 wt %, 4.5 wt % or 5.0 wt % of the titanate, and the lower limit thereof is 0.1 wt %, 0.2 wt %, 0.5 wt %, 0.8 wt %, 1.0 wt %, 1.5 wt %, 2.0 wt %, 2.5 wt %, 3.0 wt %, 3.5 wt %, 4.0 wt % or 4.5 wt % of the titanate.

Optionally, the transesterification catalyst is at least one of acidic catalyst and basic catalyst.

Optionally, the acid catalyst comprises at least one of alcohol-soluble acid, solid acid, aluminum alkoxide, aluminum phenoxide, tetrabutyl stannate, titanium alkoxide, zirconium alkoxide, ethyl antimonite and butyl antimonite; and the basic catalyst comprises at least one of alcohol-soluble base and solid base.

Optionally, the alcohol-soluble acid is an acid that is easily soluble in alcohol.

Optionally, the alcohol-soluble base is a base that is easily soluble in alcohol.

Optionally, the alcohol-soluble acid comprises sulfuric acid, sulfonic acid and the like.

Optionally, the alcohol-soluble base comprises NaOH, KOH, NaOCH₃, organic base and the like.

Optionally, the transesterification catalyst is: a basic catalyst including bases that are easily soluble in alcohol (such as NaOH, KOH, NaOCH₃, organic bases and so on) and various solid base catalysts; and acid catalysts including acids that are easily soluble in alcohol (such as sulfuric acid, sulfonic acid and so on) and various solid acid catalysts, aluminum alkoxide, aluminum phenoxide, tetrabutyl stannate, titanium alkoxide, zirconium alkoxide, ethyl antimonite, butyl antimonite and so on; and the amount of the transesterification catalyst is in a range from 0.1 wt % to 5 wt % of the titanate.

Optionally, the conditions for the transesterification are: a reaction temperature ranges from 80 to 180° C., and a reaction time ranges from 2 to 10 hours in an inactive atmosphere.

Optionally, the inactive atmosphere comprises at least one of nitrogen and inert gas atmosphere.

Optionally, the inactive atmosphere is nitrogen atmosphere.

Optionally, the transesterification is carried out under stirring condition.

Optionally, the upper limit of the reaction temperature is 85° C., 90° C., 100° C., 110° C., 120° C., 130° C., 140° C., 150° C., 160° C., 170° C., 175° C. or 180° C., and the lower limit thereof is 80° C., 85° C., 90° C., 100° C., 110° C., 120° C., 130° C., 140° C., 150° C., 160° C., 170° C. or 175° C.

Optionally, the upper limit of the reaction time is 3 hours, 4 hours, 5 hours, 6 hours, 7 hours, 8 hours, 9 hours or 10 hours, and the lower limit thereof is 2 hours, 3 hours, 4 hours, 5 hours, 6 hours, 7 hours, 8 hours or 9 hours.

Optionally, the conversion rate of the transesterification ranges from 60% to 80%.

Optionally, the conditions for the transesterification further comprise performing vacuum distillation thereafter.

Optionally, the conditions of the vacuum distillation comprise: a vacuum degree ranges from 0.01 to 5 kPa, a vacuum distillation temperature ranges from 170 to 230° C., and a vacuum distillation time ranges from 0.5 to 5 hours.

Optionally, in the vacuum distillation process, the upper limit of the vacuum degree is 0.02 kPa, 0.05 kPa, 0.1 kPa, 0.5 kPa, 1 kPa, 2 kPa, 3 kPa, 4 kPa, 4.5 kPa or 5 kPa, and the lower limit thereof is 0.01 kPa, 0.02 kPa, 0.05 kPa, 0.1 kPa, 0.5 kPa, 1 kPa, 2 kPa, 3 kPa, 4 kPa or 4.5 kPa.

Optionally, in the vacuum distillation process, the upper limit of the vacuum distillation temperature is 175° C., 180° C., 190° C., 200° C., 210° C., 220° C., 225° C. or 230° C., and the lower limit thereof is 170° C., 175° C., 180° C., 190° C., 200° C., 210° C., 220° C. or 225° C.

Optionally, in the vacuum distillation process, the upper limit of the vacuum distillation time is 0.8 hour, 1 hour, 2 hours, 3 hours, 4 hours, 4.5 hours or 5 hours, and the lower limit thereof is 0.5 hour, 0.8 hour, 1 hour, 2 hours, 3 hours, 4 hours or 4.5 hours.

Optionally, the conversion rate of the transesterification is greater than 90%.

Optionally, the method comprises following steps:
a) mixing titanate, polyhydric alcohol and transesterification catalyst, and then performing the transesterification under stirring conditions and in an inactive protection atmosphere, wherein the reaction temperature ranges from 80 to 180° C., and the reaction time ranges from 2 to 10 hours; and
b) after the reaction in step a), performing vacuum distillation during which the vacuum degree ranges from 0.01 to 5 kPa, the reaction temperature ranges from 170 to 230° C., and the reaction time ranges from 0.5 to 5 hours.

As a specific embodiment, the method comprises following steps:
1) mixing titanate, polyhydric alcohol and transesterification catalyst uniformly in a three-necked flask, and performing the transesterification under stirring conditions during which a distillation device is connected to the three-necked flask and nitrogen is passed in the three-necked flask for protection, wherein the reaction temperature ranges from 80 to 180° C., the reaction time ranges from 2 to 10 hours, and the conversion rate of the transesterification ranges from 60% to 80%; and
2) after step 1), connecting the distillation device to the water pump or oil pump for vacuum distillation to make the transesterification more complete, wherein the vacuum degree is controlled to range from 0.01 to 5 kPa, the reaction temperature ranges from 170 to 230° C., the reaction time ranges from 0.5 to 5 hours, and the conversion rate of the transesterification is greater than 90%.

Optionally, the molar ratio of the titanate polyester polyol, the silicon source, the template and water satisfies:
titanate polyester polyol: silicon source=0.005˜0.1;
template: silicon source=0.01˜10;
H₂O: silicon source=5˜500;
wherein, the number of moles of the template is based on the number of moles of N atom in the template;
the number of moles of titanate polyester polyol is based on the number of moles of TiO₂;
the number of moles of the silicon source is based on the number of moles of SiO₂; and
the number of moles of water is based on the number of moles of H₂O itself.

Optionally, the upper limit of the molar ratio of the titanate polyester polyol to the silicon source is 0.008, 0.01, 0.02, 0.03, 0.04, 0.05, 0.06, 0.07, 0.08, 0.09 or 0.1, and the lower limit thereof is 0.005, 0.008, 0.01, 0.02, 0.03, 0.04, 0.05, 0.06, 0.07, 0.08 or 0.09; wherein, the number of moles of the titanate polyester polyol is based on the number of moles of TiO₂, and the number of moles of the silicon source is based on the number of moles of SiO₂.

Optionally, the upper limit of the molar ratio of the template to the silicon source is 0.02, 0.05, 0.1, 0.2, 0.5, 0.8, 1, 2, 5, 8 or 10, and the lower limit thereof is 0.01, 0.02, 0.05, 0.1, 0.2, 0.5, 0.8, 1, 2, 5 or 8; wherein, the number of moles of the template is based on the number of moles of N atom in the template; and the number of moles of the silicon source is based on the number of moles of SiO₂.

Optionally, the upper limit of the molar ratio of the water to the silicon source is 8, 10, 20, 50, 80, 100, 150, 200, 250, 300, 350, 400, 450 or 500, and the lower limit thereof is 5, 8, 10, 20, 50, 80, 100, 150, 200, 250, 300, 350, 400 or 450; wherein the number of moles of water is based on the number of moles of H₂O itself; and the number of moles of the silicon source is based on the number of moles of SiO₂.

Optionally, the molar ratio of the titanate polyester polyol, the silicon source, the template and water satisfies:
titanate polyester polyol: silicon source=0.01˜0.08;
template: silicon source=0.05˜5;
H₂O:silicon source=20˜400;
wherein, the number of moles of the template is based on the number of moles of N atom in the template;
the number of moles of the titanate polyester polyol is based on the number of moles of TiO₂;
the number of moles of the silicon source is based on the number of moles of SiO₂; and
the number of moles of water is based on the number of moles of H₂O itself.

Optionally, the silicon source is at least one of silica sol, tetratetraethyl orthosilicate, tetramethoxysilane and white carbon black.

Specifically, the silicon source is one or more of silica sol, tetratetraethyl orthosilicate, tetramethoxysilane and white carbon black.

Optionally, the template refers to at least one of organic base templates.

Optionally, the molar ratio of the titanate polyester polyol, the silicon source, the organic base template and water satisfies:
TiO₂/SiO₂=0.005˜0.1;
organic base template/(SiO₂+TiO₂)=0.01˜10;
H₂O/SiO₂=5˜500;
wherein, the silicon content in the silicon source is calculated by the number of moles of SiO₂;
the titanium content in the titanate polyester polyol is calculated by the number of moles of TiO₂;
the content of the organic base template is calculated by the number of the moles of N atom; and
the number of moles of water is based on the number of moles of H₂O itself.

Optionally, the molar ratio of the titanate polyester polyol, the organic base template, the silicon source and water satisfies:
TiO₂/SiO₂=0.01˜0.08;
organic base template/SiO₂=0.05˜5;
H₂O/SiO₂=20˜400;
wherein, the silicon content in the silicon source is calculated by the number of moles of SiO₂;
the titanium content in the titanate polyester polyol is calculated by the number of moles of TiO₂; and
the content of the organic base template is calculated by the number of the moles of N atom.

Optionally, the organic base template comprises A which is at least one of tetraethylammonium hydroxide, tetrapropylammonium hydroxide, tetrabutylammonium hydroxide, triethylpropylammonium hydroxide, tetrapropylammonium halide, tetraethylammonium halide, tetrabutylammonium halide and triethylpropylammonium halide.

Optionally, the organic base template further comprises B which is at least one of aliphatic amine and alcohol amine compounds.

Optionally, B comprises at least one of ethylamine, diethylamine, triethylamine, n-butylamine, butanediamine, hexamethylenediamine, octanediamine, monoethanolamine, diethanolamine, and triethanolamine.

Optionally, the organic base template is at least one of tetraethylammonium hydroxide, tetrapropylammonium hydroxide, tetrabutylammonium hydroxide, triethylpropylammonium hydroxide, tetrapropylammonium halide, tetraethylammonium halide, tetrabutylammonium halide, triethylpropylammonium halide and the like. Alternatively, the organic base template is a mixture of these quaternary ammonium salts or quaternary ammonium bases and aliphatic amine or alcohol amine compounds which is exemplified as ethylamine, diethylamine, triethylamine, n-butylamine, butanediamine, hexamethylene diamine, octanediamine, monoethanolamine, diethanolamine, triethanolamine and the like.

Optionally, the conditions of crystallization are: the crystallization is conducted in sealed condition, a crystallization temperature ranges from 100 to 200° C., and the crystallization time under autogenous pressure does not exceed 30 days.

Optionally, the conditions of crystallization were: the crystallization is conducted in sealed condition, the crystallization temperature ranges from 110 to 180° C., and the crystallization time under autogenous pressure ranges from 1 to 28 days.

Optionally, the conditions of crystallization were: the crystallization is conducted in sealed condition, the crystallization temperature ranges from 120 to 190° C., and the crystallization time under autogenous pressure ranges from 1 to 15 days.

Optionally, the upper limit of the crystallization temperature is 110° C., 120° C., 130° C., 140° C., 150° C., 160° C., 170° C., 180° C., 190° C. or 200° C., and the lower limit thereof is 100° C., 110° C., 120° C., 130° C., 140° C., 150° C., 160° C., 170° C., 180° C. or 190° C.

Optionally, the upper limit of crystallization time is 1 hour, 5 hours, 10 hours, 15 hours, 20 hours, 1 day, 2 days, 5 days, 10 days, 12 days, 15 days, 20 days, 25 days, 28 days or 30 days, and the lower limit thereof is 0.5 hour, 1 hour, 5 hours, 10 hours, 15 hours, 20 hours, 1 day, 2 days, 5 days, 10 days, 12 days, 15 days, 20 days, 25 days, or 28 days.

Optionally, the crystallization is performed dynamically or statically.

Optionally, the mixture is subject to aging or not subject to aging to obtain a gel mixture.

Optionally, the mixture undergoes crystallization after aging, and conditions of aging are that aging temperature is not higher than 120° C. for an aging time in a range from 0 to 100 hours.

Optionally, the conditions of aging are the aging temperature ranges from 0 to 120° C. for the aging time in a range from 0 to 100 hours.

Optionally, the conditions of aging are the aging temperature ranges from 20 to 80° C. for the aging time in a range from 0 to 80 hours.

Optionally, the aging is performed dynamically or statically.

Optionally, after the crystallization is completed, the solid product is separated, washed to be neutral, and dried to obtain the TS-1 molecular sieve.

Optionally, the method for preparing TS-1 molecular sieve comprises:
a) mixing a titanate polyester polyol with a silicon source, an organic base template and water, and keeping the obtained mixture at a temperature not higher than 120° C. for aging for a time in a range from 0 to 100 hours to obtain a gel mixture;
b) crystalizing the gel mixture obtained in step a) under sealed conditions to obtain the TS-1 molecular sieve, wherein a crystallization temperature is raised to a range from 100 to 200° C., and a crystallization time ranges from 0 to 30 days under autogenous pressure.

As a specific embodiment, the method for preparing TS-1 molecular sieve comprises:
a′) mixing the titanate polyester polyol with the silicon source, the organic base template and water, and keeping the obtained mixture at a temperature not higher than 120° C. for stirring or static aging for a time in a range from 0 to 100 hours to obtain a gel mixture;
b′) transferring the gel mixture obtained in step a′) into an autoclave which is then sealed, and crystalizing the gel mixture under the condition that the crystallization temperature is raised to a range from 100 to 200° C. and a crystallization time ranges from 0 to 30 days under autogenous pressure;
e′) after the crystallization is completed, separating the solid product, washing the same with deionized water to be neutral, and drying the same to obtain the hierarchical porous TS-1 molecular sieve.

Optionally, the hierarchical porous TS-1 molecular sieve comprises mesopores, and the pore diameter thereof ranges from 2 to 10 nm.

Optionally, the particle size of the hierarchical porous titanium-silicon TS-1 molecular sieve ranges from 100 to 500 nm.

Optionally, the hierarchical porous titanium-silicon TS-1 molecular sieve has a mesoporous structure with a narrower pore size distribution and less non-framework titanium.

Optionally, the TS-1 molecular sieve is used for the selective oxidation reaction of organic substances in the presence of H₂O₂.

Compared with the conventional preparation process, titanium is connected to a polymer, which makes titanium more difficult to hydrolyze, prevent the TiO₂ precipitation and facilitate the entry of titanium into the molecular sieve framework. In addition that such new type of titanate polyester polyol acts as the titanium source during the synthesis process, the titanate polyester polyol can also be used as mesoporous template. The TS-1 molecular sieve obtained by this method has mesoporous structure and has less non-framework titanium.

In the present application, “C₁˜C₈” and the like all refer to the number of carbon atoms contained in a group.

The beneficial effects that the present application can achieve comprise followings:

1) The present application uses the titanate polyester polyol as the titanium source. Titanium is connected to the polymer, making titanium more difficult to hydrolyze, preventing the TiO₂ precipitation and reducing the formation of non-framework titanium;

2) In the method of the present application, the titanate polyester polyol not only is used as titanium source, but also can be used as a mesoporous template. The obtained TS-1 molecular sieve has mesoporous structure and has less non-framework titanium.

### BRIEF DESCRIPTION OF FIGURES

FIG. 1 shows XRD pattern of the product prepared according to Example 1 of the present invention.

FIG. 2 shows SEM image of the product prepared according to Example 1 of the present invention.

FIG. 3 shows ultraviolet-visible (UV-VIS) spectrum of the product prepared according to Example 1 of the present invention.

FIG. 4 shows the results of physical adsorption and pore size distribution of the product prepared according to Example 1 of the present invention.

### DETAILED DESCRIPTION

The present application will be described in detail below with reference to the examples, but the present application is not limited to these examples.

Unless otherwise specified, the raw materials in the examples of the present application are all commercially available.

In the present application, the X-Ray Diffraction Analysis (XRD) of the product is performed by the X'Pert PRO X-Ray Diffractometer from PANalytical Company, wherein the XRD is performed under conditions of the Cu target Kα radiation source (λ=0.15418 nm), electric voltage=40 KV, and electric current=40 mA.

In the present application, the SEM image of the product is obtained by Hitachi TM3000 SEM.

In the present application, the ultraviolet-visible diffuse reflectance spectrum of the product is measured on a Varian Cary500 Scan UV-Vis spectrophotometer equipped with an integrating sphere.

In the present application, the physical adsorption, external specific surface area and pore size distribution analysis of the product are performed by the ASAP2020 automatic physics instrument from Mike.

In the present application, the titanate polyester polyol is used as titanium source, and an organic base template, a silicon source and deionized water are added therein to synthesize hierarchical porous TS-1 molecular sieve under hydrothermal conditions.

According to an embodiment of the present application, the method for preparing the hierarchical porous TS-1 molecular sieve is as follows:
a) mixing the titanate polyester polyol, the organic base template, the silicon source and water in a certain proportion to obtain a gel mixture, wherein, preferably, the gel mixture has the following molar ratio:
TiO₂/SiO₂=0.005˜0.1;
organic base template/SiO₂=0.01˜10;
H₂O/SiO₂=5˜500;
wherein the silicon content in the silicon source is calculated by the number of moles of SiO₂, the titanium content in the titanate polyester polyol is calculated by the number of moles of TiO₂, and the content of the organic base template is calculated by the number of the moles of N atom;
b) subjecting the gel mixture obtained in step a) to an aging process, which can be omitted or can be carried out, wherein the aging can be carried out under stirring or static conditions, an aging temperature ranges from 0 to 120° C., and an aging time ranges from 0 to 100 hours;
c) transferring the gel mixture after step b) into an autoclave which is then sealed, and crystalizing the gel mixture under the condition that the crystallization temperature is raised to a range from 100 to 200° C., and a crystallization time ranges from 1 to 30 days; and
d) after the crystallization is completed, separating the solid product, washing the same with deionized water to be neutral, and drying the same to obtain the hierarchical porous TS-1 molecular sieve.

Preferably, the organic base template in step a) is at least one of tetraethylammonium hydroxide, tetrapropylammonium hydroxide, tetrabutylammonium hydroxide, triethylpropylammonium hydroxide, tetrapropylammonium halide, tetraethylammonium halide, tetrabutylammonium halide, triethylpropylammonium halide and the like; alternatively, the organic base template is a mixture of these quaternary ammonium salts or quaternary ammonium bases and aliphatic amine or alcohol amine compounds which is exemplified as ethylamine, n-butylamine, butanediamine, hexamethylene diamine, octanediamine, monoethanolamine, diethanolamine, triethanolamine and the like.

Preferably, TiO₂/SiO₂=0.01˜8 in the gel mixture in step a).

Preferably, organic base template/SiO₂=0.05˜5 in the gel mixture in step a).

Preferably, H₂O/SiO₂=20˜400 in the gel mixture in step a).

Preferably, the aging process in step b) can be omitted or can be carried out, wherein an aging temperature ranges from 20 to 80° C., and an aging time ranges from 0 to 80 hours.

Preferably, in step c), the crystallization temperature ranges from 120 to 190° C., and the crystallization time ranges from 1 to 15 days.

Preferably, the crystallization process in step c) is performed statically or dynamically.

Preferably, the hierarchical porous TS-1 molecular sieve is obtained in the step d).

### Example 1

The specific raw materials, amounts thereof, crystallization temperature and time, XRD crystal form and external specific surface area are shown in Table 1 below.

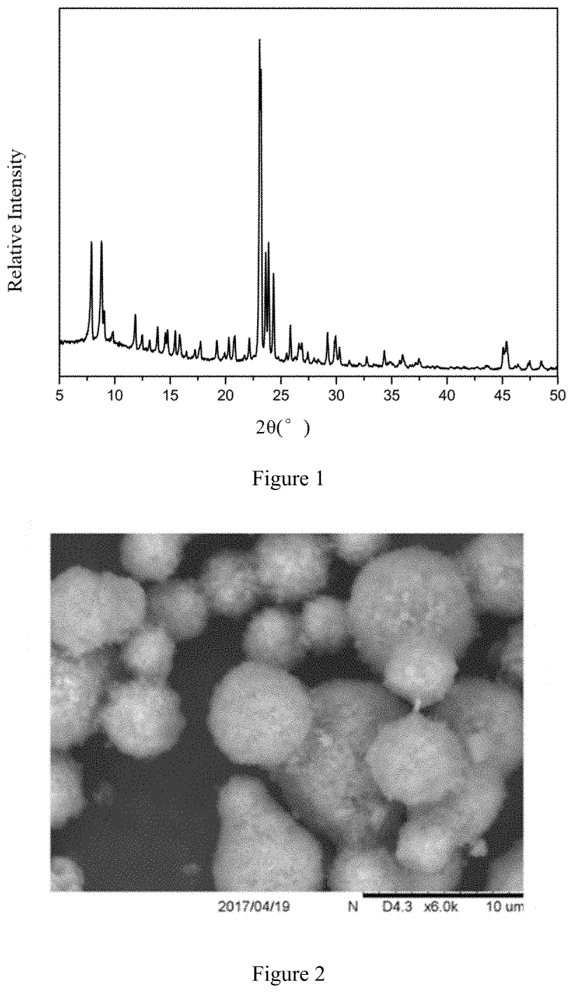

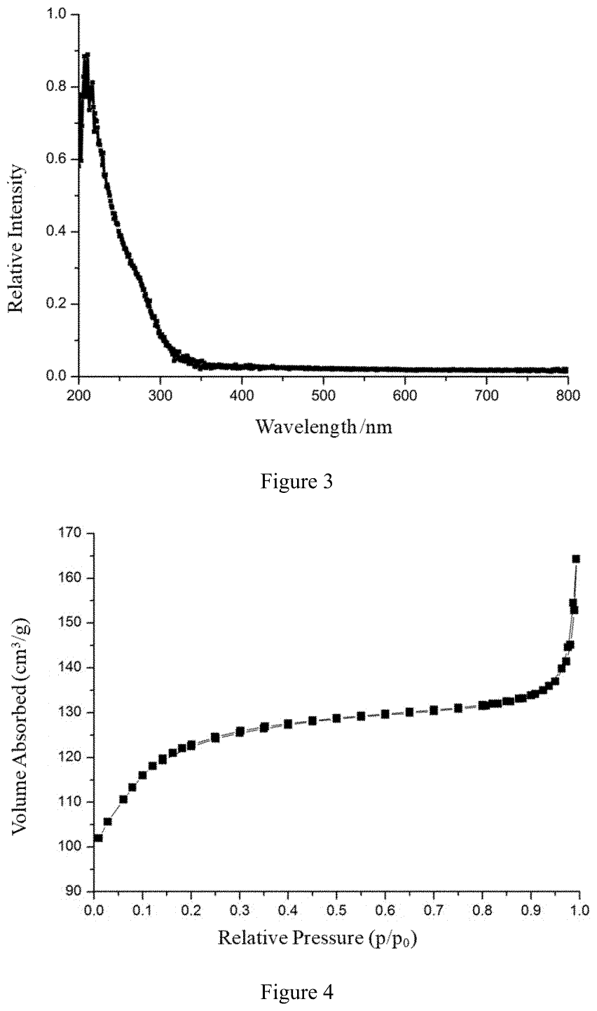

In Example 1, the specific process is as follows: 6.76 g tetrapropylammonium hydroxide (25 wt %) aqueous solution, 1 g white carbon black, 10 g water are added to 0.14 g titanate ethylene glycol polyester, which are mixed uniformly, and stirred at room temperature for 2 hours. Then, the obtained mixture is transferred to a stainless steel autoclave, wherein the molar ratio of all components herein is 0.05[Ti(OCH₂CH₂O)₂]₂₀:SiO₂:0.5TPAOH:50H₂O. The autoclave is sealed and placed in an oven that has been raised to a constant temperature of 170° C., and crystallization step under autogenous pressure is performed for 2 days. After crystallization is completed, the solid product is separated by centrifugation, washed with deionized water to be neutral, and dried in air at 110° C. to obtain a hierarchical porous TS-1 molecular sieve. The obtained hierarchical porous TS-1 molecular sieve is subject to XRD analysis, the result of which is shown in FIG. 1. As can be seen from FIG. 1, the obtained sample is proved to be TS-1 molecular sieve. The SEM image of the obtained hierarchical porous TS-1 molecular sieve is shown in FIG. 2. As can be seen from FIG. 2, the hierarchical porous TS-1 molecular sieve has the morphology of stacked small crystal grains. The UV-VIS diffuse reflectance spectrum of the obtained hierarchical porous TS-1 molecular sieve is shown in FIG. 3. As can be seen from FIG. 3, almost no non-framework titanium exists in the obtained hierarchical porous TS-1 molecular sieve. The physical adsorption curve of the obtained hierarchical porous TS-1 molecular sieve is shown in FIG. 4.

The method for preparing the titanate ethylene glycol polyester is as follows: 5 g ethylene glycol and 9.2 g tetraethyl orthosilicate are added into a three-necked flask which is connected to a distillation device. 0.12 g concentrated sulfuric acid (98 wt %) as transesterification catalyst is added dropwise in the three-necked flask under stirring condition. The temperature is heated up to 175° C. under nitrogen protection, and the reaction time is 5 hours. During this process, a large amount of ethanol are distilled out, and the conversion rate of the transesterification is 89%. Then a vacuum device is connected to distillation device and the transesterification continues under vacuum distillation conditions, wherein the vacuum degree of the reaction system was controlled to be 0.1 kPa and the temperature was raised to 210° C. After reacting for 3 hours, the transesterification is stopped. After the temperature is naturally cooled to be room temperature, the resulting sample is taken, and the conversion rate of the transesterification is 95%.

The conversion rate of the transesterification in the Examples of the present application is calculated as follows.

According to the number of moles n of the by-product alcohols distilled out during the reaction, the number of groups participating in the transesterification is determined to be n, and the total number of moles of esters in the reaction raw materials is in, and then the conversion rate of the transesterification is n/xm; wherein x depends on the number of alkoxy groups connected to the central atom in the esters.

The prepared sample is subject to thermogravimetric test which is conducted by TA Q-600 thermogravimetric analyzer from TA Instruments. During the thermogravimetric test, the nitrogen flow rate is 100m1/min, and the temperature is increased to 700° C. at a temperature rise rate of 10° C./min. According to the reaction conversion rate x, the degree of polymerization n of the product can be determined: n=1/(1−x). The chemical formula of the obtained sample is [Ti(OCH₂CH₂O)₂]₂₀.

### Examples 2 to 13

The specific raw materials, amounts thereof and reaction conditions different from Example 1 and corresponding analysis results are shown in Table 1 below, and the other procedures are the same as those in Example 1.

TABLE 1
Raw materials, amounts thereof and crystallization conditions of Examples 2 to 13

| | | | | | Crystal- | Crystal- | | External |
|---|---|---|---|---|---|---|---|---|
| | | Silicon | Organic base | | lization | lization | XRD | specific |
| Example | Titanate polyester polyol | source | compound | water | temperature | time | crystal | surface |
| Numbering | (mol) | (mol) | (mol) | (mol) | (° C.) | (day) | form | area |
| 2 | [Ti (ROₓ)_{4/x}]ₙ; | White | Tetrapropyl | 50 mol | 170 | 4 | TS-1 | 185 |
| | R is a group formed by losing two | carbon black | ammonium | | | | | |
| | hydrogen atoms on the hydroxyl | 1 mol | hydroxide | | | | | |
| | groups of ethylene glycol, | | 0.5 mol | | | | | |
| | x = 2, n = 12 | | | | | | | |
| | 0.005 mol | | | | | | | |
| 3 | [Ti (ROₓ)_{4/x}]ₙ; | White | Tetrapropyl | 50 mol | 170 | 4 | TS-1 | 145 |
| | R is a group formed by losing two | carbon black | ammonium | | | | | |
| | hydrogen atoms on the hydroxyl | 1 mol | hydroxide | | | | | |
| | groups of 1,3-propanediol, | | 0.5 mol | | | | | |
| | x = 2, n = 11 | | | | | | | |
| | 0.01 mol | | | | | | | |
| 4 | [Ti (ROₓ)_{4/x}]ₙ; | Silica sol | Tetrapropyl | 50 mol | 150 | 7 | TS-1 | 162 |
| | R is a group formed by losing three | 1 mol | ammonium | | | | | |
| | hydrogen atoms on the hydroxyl | | hydroxide | | | | | |
| | groups of glycerol, | | 1 mol | | | | | |
| | x = 3, n = 10 | | | | | | | |
| | 0.006 mol | | | | | | | |
| 5 | [Ti (ROₓ)_{4/x}]ₙ; | Silica sol | Tetrapropyl | 10 mol | 170 | 4 | TS-1 | 130 |
| | R is a group formed by losing two | 1 mol | ammonium | | | | | |
| | hydrogen atoms on the hydroxyl | | hydroxide | | | | | |
| | groups of 1,4-butanediol, | | 0.05 mol | | | | | |
| | x = 2, n = 12 | | | | | | | |
| | 0.02 mol | | | | | | | |
| 6 | [Ti (ROₓ)_{4/x}]ₙ; | Tetraethyl | Tetrapropyl | 300 mol | 170 | 1 | TS-1 | 235 |
| | R is a group formed by losing two | orthosilicate | ammonium | | | | | |
| | hydrogen atoms on the hydroxyl | 1 mol | hydroxide | | | | | |
| | groups of 1,6-hexanediol, | | 10 mol | | | | | |
| | x = 2, n = 15 | | | | | | | |
| | 0.03 mol | | | | | | | |
| 7 | [Ti (ROₓ)_{4/x}]ₙ; | Tetraethyl | Tetrapropyl | 50 mol | 100 | 20 | TS-1 | 165 |
| | R is the group formed by losing | orthosilicate | ammonium | | | | | |
| | two hydrogen atoms on the | 1 mol | hydroxide | | | | | |
| | hydroxyl groups of | | 0.5 mol | | | | | |
| | terephthalyl alcohol, | | | | | | | |
| | x = 2, n = 10 | | | | | | | |
| | 0.03 mol | | | | | | | |
| 8 | [Ti (ROₓ)_{4/x}]ₙ; | White | Tetrapropyl | 50 mol | 200 | 1 | TS-1 | 210 |
| | R is a group formed by losing two | carbon black | ammonium | | | | | |
| | hydrogen atoms on the hydroxyl | 1 mol | hydroxide | | | | | |
| | groups of 1,4-cyclohexanediol, | | 0.5 mol | | | | | |
| | x = 2, n = 11 | | | | | | | |
| | 0.008 mol | | | | | | | |
| 9 | [Ti (ROₓ)_{4/x}]ₙ; | White | Tetrapropyl | 50 mol | 170 | 7 | TS-1 | 180 |
| | R is the group formed by losing | carbon black | ammonium | | | | | |
| | two hydrogen atoms on the | 1 mol | hydroxide | | | | | |
| | hydroxyl groups of | | 0.1 mol + 5 mol | | | | | |
| | 1,4-cyclohexanedimethanol, | | n-butylamine | | | | | |
| | x = 2, n = 16 | | | | | | | |
| | 0.05 mol | | | | | | | |
| 10 | [Ti (ROₓ)_{4/x}]ₙ; | Silica sol | Tetrapropyl | 50 mol | 170 | 7 | TS-1 | 175 |
| | R is a group formed by losing two | 1 mol | ammonium | | | | | |
| | hydrogen atoms on the hydroxyl | | bromide | | | | | |
| | groups of polyethylene glycol 200, | | 0.5 mol + 10 mol | | | | | |
| | x = 2, n = 12 | | n-butylamine | | | | | |
| | 0.07 mol | | | | | | | |
| 11 | [Ti (ROₓ)_{4/x}]ₙ; | Silica sol | Tetrabutyl | 150 mol | 170 | 0.5 | TS-1 | 150 |
| | R is a group formed by losing two | 1 mol | ammonium | | | | | |
| | hydrogen atoms on the hydroxyl | | hydroxide | | | | | |
| | groups of polyethylene glycol 400, | | 1 mol + 0.1 mol | | | | | |
| | x = 2, n = 15 | | tetrapropyl | | | | | |
| | 0.035 mol | | ammonium | | | | | |
| | | | bromide | | | | | |
| 12 | [Ti (ROₓ)_{4/x}]ₙ; | Tetraethyl | Tetraethyl | 50 mol | 170 | 3 | TS-1 | 166 |
| | R is a group formed by losing two | orthosilicate | ammonium | | | | | |
| | hydrogen atoms on the hydroxyl | 1 mol | hydroxide | | | | | |
| | groups of polyethylene glycol 800, | | 0.5 mol + 0.5 mol | | | | | |
| | x = 2, n = 12 | | tetrapropyl | | | | | |
| | 0.045 mol | | ammonium | | | | | |
| | | | bromide | | | | | |
| 13 | [Ti (ROₓ)_{4/x}]ₙ; | Tetraethyl | Hexanediamine | 50 mol | 175 | 10 | TS-1 | 140 |
| | R is a group fonned by losing four | orthosilicate | 10 mol + 0.1 mol | | | | | |
| | hydrogen atoms on the hydroxyl | 1 mol | tetrapropyl | | | | | |
| | groups of pentaerythritol, | | ammonium | | | | | |
| | x = 4, n = 16 | | bromide | | | | | |
| | 0.1 mol | | | | | | | |

In Table 1, R is a group formed by losing x hydrogen atoms from hydrocarbon compounds, which is such as ethyl, propyl, butyl, a group formed by losing x hydrogen atoms from polyethylene glycol, or a group formed by losing x hydrogen atoms from para-xylene, x is in a range from 2 to 6. The crystallization in Examples 1 to 13 is static crystallization.

The method for preparing the titanate polyester polyol in Examples 2 to 13 is the same as the method for preparing the titanate ethylene glycol polyester in Example 1. The difference is that 5 g ethylene glycol in Example 1 is replaced with 6.1 g 1,3-propanediol, 5 g glycerol, 7.2 g 1,4-butanediol, 9.5 g 1,6-hexanediol, 11.1 g terephthalyl alcohol, 9.3 g 1,4-cyclohexanediol, 11.5 g 1,4-cyclohexane dimethanol, 16.8 g polyethylene glycol 200, 33.8 g polyethylene glycol 400, 65.6 g polyethylene glycol 800, 5.5 g pentaerythritol, respectively, to obtain the corresponding titanate polyester polyol in Examples 2 to 13.

### Example 14

Except that the crystallization temperature is 100° C. and the crystallization time is 30 days, the other procedures are the same as those in Example 1.

The crystallization is dynamic, which is performed by using a rotating oven. The crystallization temperature and crystallization time are the same as those in Example 1, and the rotation speed of the rotating oven is 35 rpm.

### Example 15

Aging step is performed before crystallization, and the aging step is performed statically at 120° C. for 2 hours. The other procedures are the same as those in Example 1.

### Example 16

Aging step is performed before crystallization, and the aging step is performed at 20° C. for 80 hours. The other procedures are the same as those in Example 1.

### Example 17 Phase Structure Analysis

The samples prepared in Example 1 to Example 16 are subjected to XRD phase structure analysis respectively, results of which are typically shown in FIG. 1. FIG. 1 shows the XRD pattern of the sample prepared in Example 1. As can be seen from FIG. 1, the sample in Example 1 is proved to be TS-1 molecular sieve.

The test results of other samples are only slightly different from the samples in Example 1 in terms of the intensity of the diffraction peaks, and they are all proved to be TS-1 molecular sieves.

### Example 18 Morphology Test

The samples prepared in Example 1 to Example 16 are subjected to SEM morphology analysis respectively, results of which are typically shown in FIG. 2. FIG. 2 shows the SEM image of the sample prepared in Example 1. As can be seen from FIG. 2, the sample prepared in Example 1 has the morphology of stacked small crystal grains and the particle size of the sample in Example 1 is about 100 nm.

The test results of other samples are similar to the test result of the sample in Example 1, and the particle size of the samples ranges from 100 to 500 nm.

### Example 19 Spectrum Analysis

The samples prepared in Example 1 to Example 16 were subjected to UV-VIS diffuse reflectance spectrum analysis respectively, results of which are typically shown in FIG. 3. FIG. 3 shows UV-VIS diffuse reflectance spectrum of the sample prepared in Example 1. As can be seen from FIG. 3, the sample of Example 1 almost has no non-framework titanium.

The test results of other samples are similar to those of the sample in Example 1, and there is almost no non-framework titanium in the sample.

### Example 20 Physical Adsorption Analysis

The samples prepared in Example 1 to Example 16 are subjected to physical adsorption and pore size distribution analysis respectively, results of which are typically shown in FIG. 4. FIG. 4 shows the results of physical adsorption of the sample prepared in Example 1. As can be seen from FIG. 4, the sample has typical hierarchical porous structure, and is a complex material with mesoporous and microporous structure.

Pore size distribution analysis shows that the samples prepared in Example 1 to Example 16 have mesopores of which the pore sizes range from 2 to 10 nm.

The test results of other samples are similar to the test result of sample in Example 1, and any of other samples all has typical hierarchical porous structure, and is a complex material with mesoporous and microporous structures.

The above examples are only illustrative, and do not limit the present application in any form. Any change or modification, made by the skilled in the art based on the technical content disclosed above, without departing from the spirit of the present application, is equivalent example and falls within the scope of the present application.

1. A method for preparing hierarchical porous titanium-silicon TS-1 molecular sieve comprising using a titanate polyester polyol as titanium source.

2. The method according to claim 1 comprising performing crystallization of a mixture containing the titanate polyester polyol, a silicon source, a template and water to obtain the hierarchical porous TS-1 molecular sieve, wherein the crystallization is hydrothermal crystallization.

3. The method according to claim 1, wherein the titanate polyester polyol is at least one of compounds having a chemical formula shown in Formula I:
[Ti(ROₓ)_{4/x}]ₙ Formula I
wherein, ROₓ is a group formed by losing H on OH of the organic polyhydric alcohol R(OH)ₓ, and R is a group formed by losing x hydrogen atoms on a hydrocarbon compound, x≥2; n=2˜30.

4. The method according to claim 3, wherein x=2, 3 or 4 in Formula I.

5. The method according to claim 3, wherein the titanate polyester polyol is at least one of titanate ethylene glycol polyester, titanate butylene glycol polyester, titanate polyethylene glycol polyester, titanate glycerol polyester and titanate terephthalyl alcohol polyester.

6. The method according to claim 2, wherein a molar ratio of the titanate polyester polyol, the silicon source, the template and water satisfies:
titanate polyester polyol: silicon source=0.005˜0.1;
template: silicon source=0.01˜10;
H₂O: silicon source=5˜500;
wherein, the number of moles of the template is based on the number of moles of N atom in the template;
the number of moles of titanate polyester polyol is based on the number of moles of TiO₂;
the number of moles of the silicon source is based on the number of moles of SiO₂; and
the number of moles of water is based on the number of moles of H₂O itself.

7. The method according to claim 6, wherein the molar ratio of the titanate polyester polyol, the silicon source, the template and water satisfies:
titanate polyester polyol: silicon source=0.01˜0.08;
template: silicon source=0.05˜5;
H₂O: silicon source=20˜400;
wherein, the number of moles of the template is based on the number of moles of N atom in the template;
the number of moles of the titanate polyester polyol is based on the number of moles of TiO₂;
the number of moles of the silicon source is based on the number of moles of SiO₂; and
the number of moles of water is based on the number of moles of H₂O itself.

8. The method according to claim 2, wherein the silicon source is at least one of silica sol, tetratetraethyl orthosilicate, tetramethoxysilane and white carbon black.

9. The method according to claim 2, wherein the template refers to at least one of organic base templates.

10. The method according to claim 9, wherein the organic base template comprises A which is at least one of tetraethylammonium hydroxide, tetrapropylammonium hydroxide, tetrabutylammonium hydroxide, triethylpropylammonium hydroxide, tetrapropylammonium halide, tetraethylammonium halide, tetrabutylammonium halide and triethylpropylammonium halide.

11. The method according to claim 10, wherein the organic base template further comprises B which is at least one of aliphatic amine and alcohol amine compounds.

12. The method according to claim 11, wherein B comprises at least one of ethylamine, diethylamine, triethylamine, n-butylamine, butanediamine, hexamethylenediamine, octanediamine, monoethanolamine, diethanolamine, and triethanolamine.

13. The method according to claim 2, wherein conditions of crystallization are: the crystallization is conducted in sealed condition, a crystallization temperature ranges from 100 to 200° C., and a crystallization time under autogenous pressure does not exceed 30 days.

14. The method according to claim 13, wherein conditions of crystallization are: the crystallization is conducted in sealed condition, a crystallization temperature ranges from 120 to 190° C., and a crystallization time under autogenous pressure ranges from 1 to 15 days.

15. The method according to claim 2, wherein the mixture undergoes crystallization after aging, and conditions of aging are that aging temperature is not higher than 120° C. for an aging time in a range from 0 to 100 hours.

16. The method according to claim 1 comprising following steps:
a) mixing the titanate polyester polyol with an organic base template and water, and keeping the obtained mixture at a temperature not higher than 120° C. for aging for a time in a range from 0 to 100 hours to obtain a gel mixture;
b) crystalizing the gel mixture obtained in step a) under sealed conditions to obtain the hierarchical porous titanium-silicon TS-1 molecular sieve, wherein the crystallization temperature is raised to a range from 100 to 200° C., a crystallization time does not exceed 30 days under autogenous pressure.

17. The method according to claim 1, wherein the TS-1 molecular sieve comprises mesopores, and the pore diameter thereof ranges from 2 to 10 nm.

18. The method according to claim 1, wherein a particle size of the hierarchical porous titanium-silicon TS-1 molecular sieve ranges from 100 to 500 nm.

19. A method for selective oxidation of organic substances in the presence of H₂O, the method comprising subjecting the organic substances and the H₂O₂ to a hierarchical porous titanium-silicon TS-1 molecular sieve prepared by the method according to claim 1.

20. A method for selective oxidation of organic substances in the presence of H₂O₂, the method comprising subjecting the organic substances and the H₂O₂ to a hierarchical porous titanium-silicon TS-1 molecular sieve prepared by the method according to claim 2.
